(19) United States
(12) Patent Application Publication
(10) Pub. No.: US 2016/0295416 A1
(43) Pub. Date: Oct. 6, 2016

(54) METHOD AND APPARATUS FOR PERFORMING A MESSAGE INTEGRITY CHECK

(71) Applicant: QUALCOMM Incorporated, San Diego, CA (US)

(72) Inventors: Lu Xiao, San Diego, CA (US); Suresh Bollapragada, San Diego, CA (US)

(21) Appl. No.: 14/677,602

(22) Filed: Apr. 2, 2015

(51) Int. Cl. H04W 12/10; H04L 9/32; H04L 9/06

(52) U.S. Cl. CPC H04W 12/10; H04L 9/0643; H04L 9/32

(57) ABSTRACT

Disclosed is a method for performing a message integrity check. In the method, a processor reads a message from a storage device. The message comprises a plurality of first level sections. The processor determines one or more second level sections from the plurality of first level sections. Each second level section comprises a fixed number of first level sections. A crypto engine calculates a hash value for each second level section to generate a respective calculated hash value, and a hash value for each first level section not included in a second level section to generate a respective calculated hash value. The processor compares each of the respective calculated hash values with a corresponding stored hash value. The processor provides an integrity check indication if each respective calculated hash value is equal to the corresponding stored hash value.

### BACKGROUND

1. Field

The present invention relates generally to performing a message integrity check in a file system of small sectors.

2. Background

As the storage capability of storage devices increases, an execution time for an integrity check based on calculating a hash value for an entire storage device also increases. As a result, when a target file is accessed, an integrity check is preferred to apply only at the target file to avoid unnecessary delays from accessing its adjacent area. A typical integrity check on a file may use an inline integrity check based on a hash chain. In the inline integrity check, a hash value may be calculated initially for each sector or block (usually 4 KB) of the storage device, and these hash values may be stored in a chain (or tree structure). The whole chain (or tree) of hash values is then hashed to compute an overall hash value. Prior to performing an inline integrity check on a file, the hashes of all sectors are verified first by matching the overall hash value to a previously stored hash value.

After a subsequent access to a file, an integrity check only needs to be performed on the affected sectors, i.e., the sectors storing the accessed file. This causes an efficiency issue for small sectors, e.g., 4 KB sectors, because most hash algorithms, such as SHA-1 and SHA-256, are fast for long messages but the overhead for initialization and completion is costly. For example, the driver for a hardware-based SHA-256 crypto engine usually has three functions to call: init( ), update( ), and final( ). For a short message, the communication overhead between the driver and the crypto engine takes longer than the hardware hash operation. Accordingly, a major delay due to algorithm setup and final processing may result when hashing a small sector. Thus, a hash chain based integrity check may not be efficient for a storage device using a file system of small sectors.

There is therefore a need for a technique for efficiently performing a message integrity check in a file system using small sectors.

### SUMMARY

An aspect of the invention may reside in a method for performing a message integrity check. In the method, a processor reads a message from a storage device. The message comprises a plurality of first level sections. The processor determines one or more second level sections from the plurality of first level sections. Each second level section comprises a fixed number of first level sections. A crypto engine calculates a hash value for each second level section to generate a respective calculated hash value, and a hash value for each first level section not included in a second level section to generate a respective calculated hash value. The processor compares each of the respective calculated hash values with a corresponding stored hash value. The processor provides an integrity check indication if each respective calculated hash value is equal to the corresponding stored hash value.

In more detailed aspects of the invention, the crypto engine may be a hardware crypto engine. Each second level section may comprise eight first level sections. The message may comprise a file.

Another aspect of the invention may reside in an apparatus, comprising: means for reading a message from a storage device, wherein the message comprises a plurality of first level sections; means for determining one or more second level sections from the plurality of first level sections, wherein each second level section comprises a fixed number of first level sections; means for calculating a hash value for each second level section to generate a respective calculated hash value; means for calculating a hash value for each first level section not included in a second level section to generate a respective calculated hash value; means for comparing each of the respective calculated hash values with a corresponding stored hash value; and means for providing an integrity check indication if each respective calculated hash value is equal to the corresponding stored hash value.

Another aspect of the invention may reside in an apparatus, comprising: a memory configured to store a message comprising a plurality of first level sections; a crypto engine configured to calculate a hash value for a level section; and a processor configured to: determine one or more third level sections from the plurality of first level sections, wherein each third level section comprises a first fixed number of first level sections; determine whether one or more second level sections may be formed from first level sections not included in a third level section, wherein each second level section comprises a second fixed number of first level sections, and the first fixed number is an integer multiple of the second fixed number; compare each respective calculated hash value calculated for each third level section with a corresponding stored hash value; compare each respective calculated hash value calculated for each second level section with a corresponding stored hash value; compare each respective calculated hash value calculated for each first level section, not included in a second level section or a third level section, with a corresponding stored hash value; and provide an integrity check indication if each respective calculated hash value is equal to the corresponding stored hash value.

In more detailed aspects of the invention, the each third level section may comprise 256 first level sections, and each second level section may comprise 8 first level sections.

Another aspect of the invention may reside in a computer-readable medium, comprising: code for causing a computer to read a message from a storage device, wherein the message comprises a plurality of first level sections; code for causing a computer to determine one or more second level sections from the plurality of first level sections, wherein each second level section comprises a fixed number of first level sections; code for causing the computer to calculate a hash value for each second level section to generate a respective calculated hash value; code for causing the computer to calculate a hash value for each first level section not included in a second level section to generate a respective calculated hash value; code for causing the computer to compare each of the respective calculated hash values with a corresponding stored hash value; and code for causing the computer to provide an integrity check indication if each respective calculated hash value is equal to the corresponding stored hash value.

### BRIEF DESCRIPTION OF THE DRAWINGS

FIG. 1 is a flow diagram of a method for performing a message integrity check, according to the present invention.

FIG. 2 is a block diagram showing an example of a computer for implementing the aspects of the invention.

FIG. 3 is a schematic diagram of sections of a storage device and hash values calculated over first and second levels.

FIG. 4 is a schematic diagram of sections of a storage device storing files.

FIG. 5 is a schematic diagram of sections of a storage device storing files, and hash values calculated over first and second levels for comparison with stored hash values.

FIG. 6 is a schematic diagram of sections of a storage device with respect to first, second, and third levels.

FIG. 7 is a block diagram of an example of a wireless communication system.

### DETAILED DESCRIPTION

The word “exemplary” is used herein to mean “serving as an example, instance, or illustration.” Any embodiment described herein as “exemplary” is not necessarily to be construed as preferred or advantageous over other embodiments.

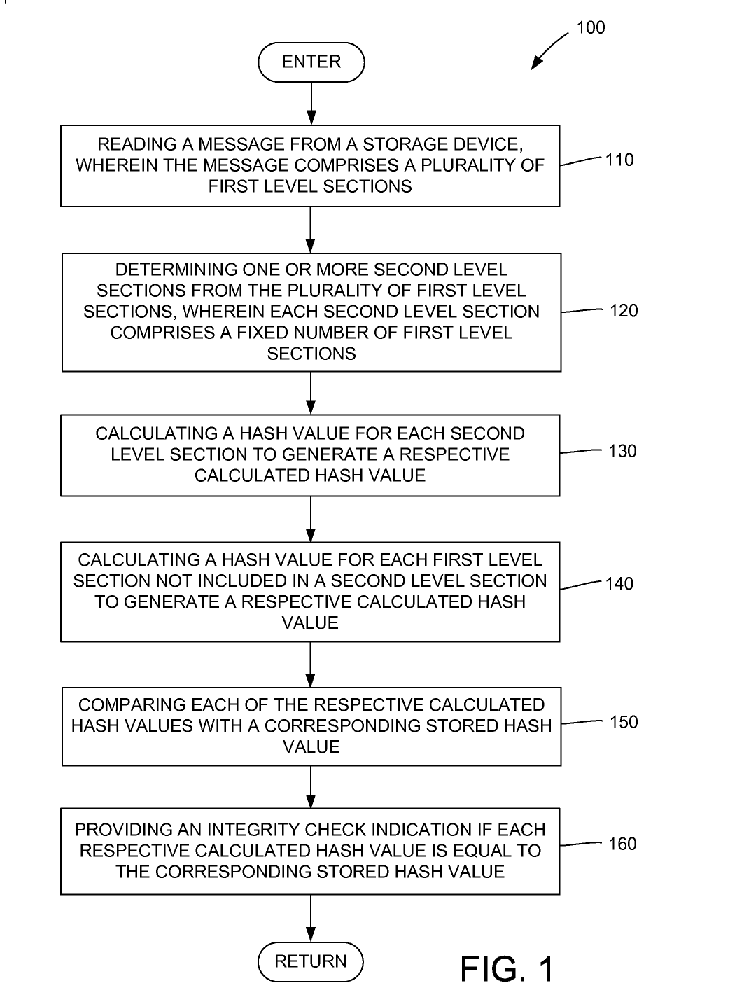

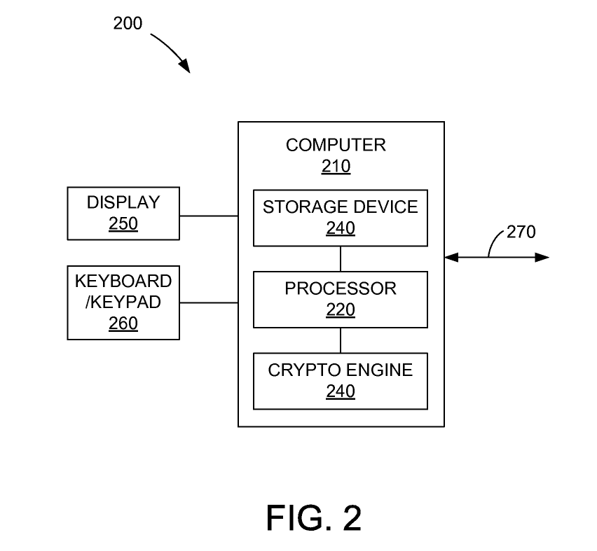

With reference to FIGS. 1-5, an aspect of the invention may reside in a method 100 for performing a message integrity check. In the method, a processor 220 reads a message (e.g., a file) from a storage device 230 (step 110). The message comprises a plurality of first level sections (S(M) to S(M+i)), where M is an index for a first level section and i is an index for a message length. The processor determines one or more second level sections (2^{nd}L(N) to 2^{nd}L(N+j)) from the plurality of first level sections (step 120), where N is an index for a second level section and j is an index for a length. Each second level section comprises a fixed number of first level sections. A crypto engine 240 calculates a hash value H_{L2} for each second level section to generate a respective calculated hash value (step 130), and a hash value H_{L1} for each first level section not included in a second level section to generate a respective calculated hash value (step 140). The processor compares each of the respective calculated hash values with a corresponding stored hash value (step 150). The processor provides an integrity check indication if each respective calculated hash value is equal to the corresponding stored hash value (step 160).

Alternatively, the integrity check may skip per-hash verification by only checking the final hash chain's integrity. After the hash chain is verified, a subsequent random access to a given level section may perform an integrity check only on the corresponding hash value, which has been verified initially.

In more detailed aspects of the invention, the storage device 230 may comprises a flash memory, or a disk drive. The crypto engine 240 may be a hardware crypto engine, or a software implementation with a crypto API. Each second level section 2^{nd}L(N) may comprise eight first level sections S(M). The message may comprise a file.

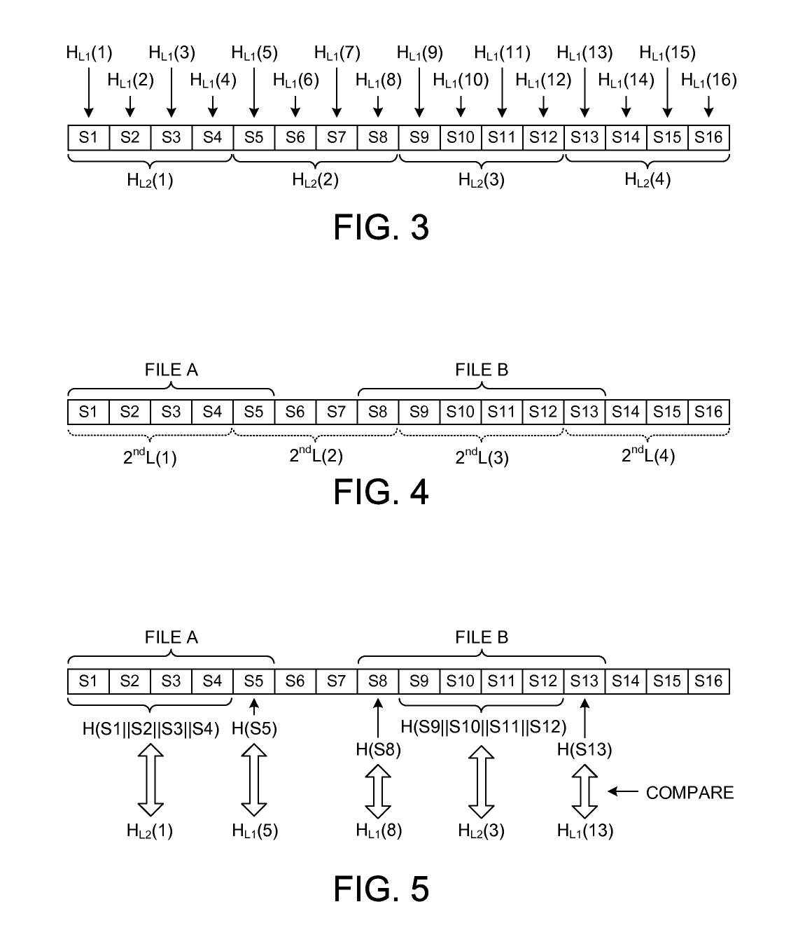

An advantage of the invention may include the use of multiple levels of hash chains with different section lengths for the same storage device 230. As shown in FIG. 3, a first level may involve hashing each section to generate corresponding first level hash values H_{L1}(K), where K is an index the corresponds to the respective section index. Each first level section may be a disk sector or a data block. A second level may involve hashing multiple contiguous first level sections. For illustrative purposes, FIG. 3 shows each second level section being aligned with 4 first level sections. However, each second level section may be aligned with 8 first level sections, 16 first level section, etc. To verify the integrity of a file of i adjacent first level sections, the first and second level sections are selected to find a combination of first and second level hash values that efficiently partition the files so that it will be covered by a least number of hash function calls required to perform the verification with existing hash chains. The hash function calls may be SHA-1 and SHA-256.

Thus, an inline integrity check may be performed using hash chains based on adaptive section lengths. Multiple level hash chains based on hashes on differing adjacent sector section lengths provides for efficiency in file systems using small sectors.

FIG. 4 shows examples of two stored files. File A is stored in first level sections S1 though S5, and File B is stored in first level sections S8 though S13. To verify File A's integrity, a hash (H(S1∥S2∥S3∥S4)) is calculated for second level section 1 (2^{nd}L(1)), and a hash (H(S5)) is calculated for first level section S5, as shown in FIG. 5. The calculated hash values are compared with the respective stored hash values H_{L2}(1) and H_{L1}(5). Thus, only two hash function calls (instead of 5) are required to check the integrity of File A, resulting in a substantial time efficiency. To verify File B's integrity, a hash (H(S9∥S10∥S11∥S12)) is calculated for second level section 3 (2^{nd}L(3)), and hashes (H(S8) and H(S13)) are calculated for first level sections S8 and S13. The calculated hash values are compared with the respective stored hash values H_{L2}(3), H_{L1}(8) and H_{L1}(13). Thus, only three hash function calls (instead of 6) are required to check the integrity of File B, again resulting in a substantial time efficiency. Also the hash function input for each level is directly from the original message, rather than from hashes of lower levels.

Another aspect of the invention may reside in an apparatus, comprising: means (e.g., processor 220) for reading a message from a storage device 230, wherein the message comprises a plurality of first level sections; means (e.g., processor 220) for determining one or more second level sections from the plurality of first level sections, wherein each second level section comprises a fixed number of first level sections; means (e.g., crypto engine 240) for calculating a hash value for each second level section to generate a respective calculated hash value; means (e.g., crypto engine 240) for calculating a hash value for each first level section not included in a second level section to generate a respective calculated hash value; means (e.g., processor 220) for comparing each of the respective calculated hash values with a corresponding stored hash value; and means (e.g., processor 220) for providing an integrity check indication if each respective calculated hash value is equal to the corresponding stored hash value.

Another aspect of the invention may reside in an apparatus 200, comprising: a memory 230 configured to store a message comprising a plurality of first level sections; a crypto engine 240 configured to calculate a hash value for a level section; and a processor 220 configured to: determine one or more second level sections from the plurality of first level sections, wherein each second level section comprises a fixed number of first level sections; compare each respective calculated hash value calculated for each second level section with a corresponding stored hash value; compare each respective calculated hash value calculated for each first level section not included in a second level section with a corresponding stored hash value; and provide an integrity check indication if each respective calculated hash value is equal to the corresponding stored hash value:

Another aspect of the invention may reside in a computer-readable medium 230, comprising: code for causing a computer 210 to read a stored message, wherein the message comprises a plurality of first level sections; code for causing the computer 210 to determine one or more second level sections from the plurality of first level sections, wherein each second level section comprises a fixed number of first level sections; code for causing the computer 210 to calculate a hash value for each second level section to generate a respective calculated hash value; code for causing the computer 210 to calculate a hash value for each first level section not included in a second level section to generate a respective calculated hash value; code for causing the computer 210 to compare each of the respective calculated hash values with a corresponding stored hash value; and code for causing the computer 210 to provide an integrity check indication if each respective calculated hash value is equal to the corresponding stored hash value.

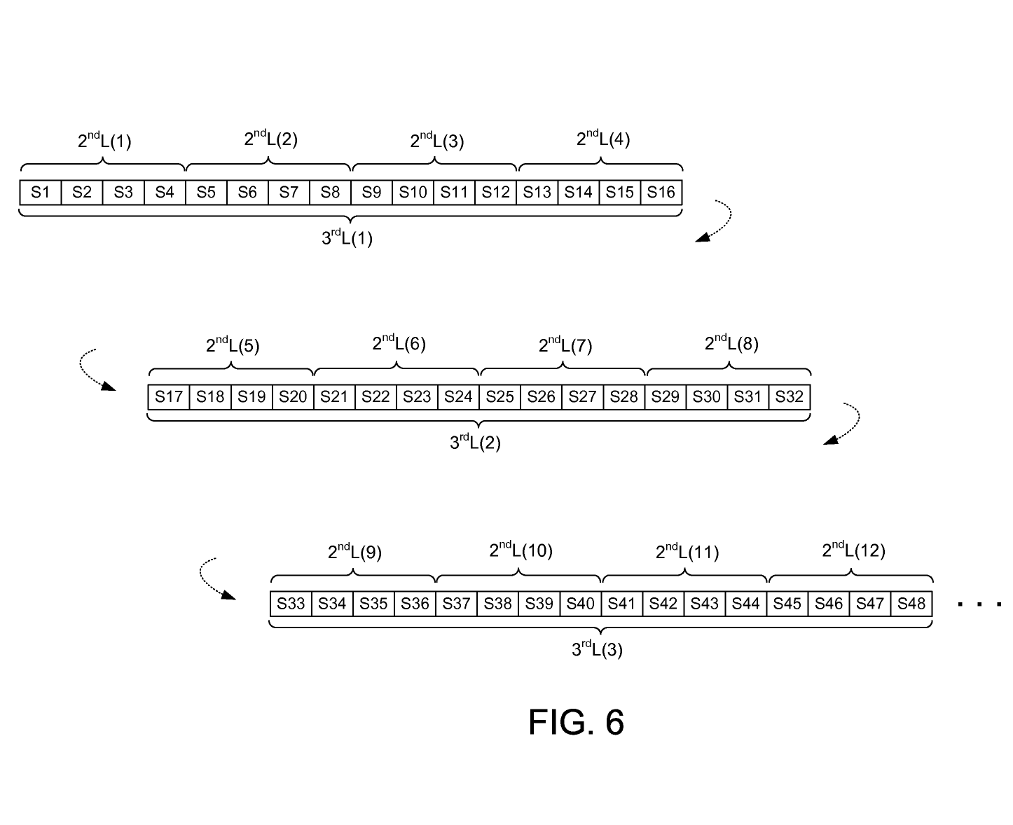

More levels may be used as shown in FIG. 6. For example, a third level may involve hashing 16 first level sections. Thus, to verify a file stored in 22 first level sections over S15 though 36, one third level hash over S17 through S32, one second level hash over S33 through S36, and two first level hashes for S15 and S15 would need to be performed. Thus, a total of 4 function calls/hash operations would need to be performed, instead of 22 function calls/has operations. Other configurations of the number of first level sections in the second and third level sections may be used.

Another aspect of the invention may reside in an apparatus 200, comprising: a memory 230 configured to store a message comprises a plurality of first level sections; a crypto engine 240 configured to calculate a hash value for a level section; and a processor 220 configured to: determine one or more third level sections from the plurality of first level sections, wherein each third level section comprises a first fixed number of first level sections; determine whether one or more second level sections may be formed from first level sections not included in a third level section, wherein each second level section comprises a second fixed number of first level sections, and the first fixed number is an integer multiple of the second fixed number; compare each respective calculated hash value calculated for each third level section with a corresponding stored hash value; compare each respective calculated hash value calculated for each second level section with a corresponding stored hash value; compare each respective calculated hash value calculated for each first level section, not included in a second level section or a third level section, with a corresponding stored hash value; and provide an integrity check indication if each respective calculated hash value is equal to the corresponding stored hash value.

In more detailed aspects of the invention, the each third level section may comprise 256 first level sections, and each second level section may comprise 8 first level sections.

The apparatus 200 (or a station) may be a computer 210 that includes a processor 220, memory 230 (and/or disk drives), a crypto engine 240, a display 250, and keypad or keyboard 260. The computer may also include a microphone, speaker(s), camera, and the like. Further, the device may also include USB, Ethernet and similar interfaces, for communicating over a network 270, such as the internet, with other devices and/or servers.

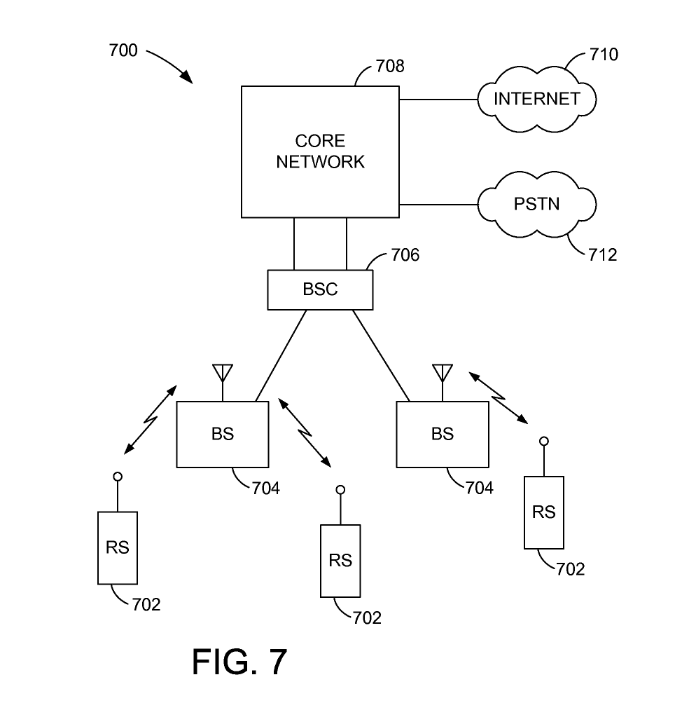

With reference to FIG. 7, a wireless remote station (RS) 702 (user equipment UE and/or apparatus 200) may communicate with one or more base stations (BS) 704 of a wireless communication system 700. The RS may further pair with a wireless peer device. The wireless communication system 700 may further include one or more base station controllers (BSC) 706, and a core network 708. The core network may be connected to an Internet 710 and a Public Switched Telephone Network (PSTN) 712 via suitable backhauls. A typical wireless mobile station may include a handheld phone, or a laptop computer. The wireless communication system 700 may employ any one of a number of multiple access techniques such as code division multiple access (CDMA), time division multiple access (TDMA), frequency division multiple access (FDMA), space division multiple access (SDMA), polarization division multiple access (PDMA), or other modulation techniques known in the art.

Those of skill in the art would understand that information and signals may be represented using any of a variety of different technologies and techniques. For example, data, instructions, commands, information, signals, bits, symbols, and chips that may be referenced throughout the above description may be represented by voltages, currents, electromagnetic waves, magnetic fields or particles, optical fields or particles, or any combination thereof.

Those of skill would further appreciate that the various illustrative logical blocks, modules, circuits, and algorithm steps described in connection with the embodiments disclosed herein may be implemented as electronic hardware, computer software, or combinations of both. To clearly illustrate this interchangeability of hardware and software, various illustrative components, blocks, modules, circuits, and steps have been described above generally in terms of their functionality. Whether such functionality is implemented as hardware or software depends upon the particular application and design constraints imposed on the overall system. Skilled artisans may implement the described functionality in varying ways for each particular application, but such implementation decisions should not be interpreted as causing a departure from the scope of the present invention.

The various illustrative logical blocks, modules, and circuits described in connection with the embodiments disclosed herein may be implemented or performed with a general purpose processor, a digital signal processor (DSP), an application specific integrated circuit (ASIC), a field programmable gate array (FPGA) or other programmable logic device, discrete gate or transistor logic, discrete hardware components, or any combination thereof designed to perform the functions described herein. A general purpose processor may be a microprocessor, but in the alternative, the processor may be any conventional processor, controller, microcontroller, or state machine. A processor may also be implemented as a combination of computing devices, e.g., a combination of a DSP and a microprocessor, a plurality of microprocessors, one or more microprocessors in conjunction with a DSP core, or any other such configuration.

The steps of a method or algorithm described in connection with the embodiments disclosed herein may be embodied directly in hardware, in a software module executed by a processor, or in a combination of the two. A software module may reside in RAM memory, flash memory, ROM memory, EPROM memory, EEPROM memory, registers, hard disk, a removable disk, a CD-ROM, or any other form of storage medium known in the art. An exemplary storage medium is coupled to the processor such the processor can read information from, and write information to, the storage medium. In the alternative, the storage medium may be integral to the processor. The processor and the storage medium may reside in an ASIC. The ASIC may reside in a user terminal. In the alternative, the processor and the storage medium may reside as discrete components in a user terminal.

In one or more exemplary embodiments, the functions described may be implemented in hardware, software, firmware, or any combination thereof. If implemented in software as a computer program product, the functions may be stored on as one or more instructions or code on a computer-readable medium. Computer-readable media includes computer storage media that facilitates transfer of a computer program from one place to another. A storage media may be any available media that can be accessed by a computer. By way of example, and not limitation, such computer-readable media can comprise RAM, ROM, EEPROM, CD-ROM or other optical disk storage, magnetic disk storage or other magnetic storage devices, or any other medium that can be used to store desired program code in the form of instructions or data structures and that can be accessed by a computer. Disk and disc, as used herein, includes compact disc (CD), laser disc, optical disc, digital versatile disc (DVD), floppy disk and blu-ray disc where disks usually reproduce data magnetically, while discs reproduce data optically with lasers. Combinations of the above should also be included within the scope of computer-readable media. The computer-readable medium may be non-transitory such that it does not include a transitory, propagating signal.

The previous description of the disclosed embodiments is provided to enable any person skilled in the art to make or use the present invention. Various modifications to these embodiments will be readily apparent to those skilled in the art, and the generic principles defined herein may be applied to other embodiments without departing from the spirit or scope of the invention. Thus, the present invention is not intended to be limited to the embodiments shown herein but is to be accorded the widest scope consistent with the principles and novel features disclosed herein.

What is claimed is:

1. A method for performing a message integrity check, comprising:
reading, by a processor, a message from a storage device, wherein the message comprises a plurality of first level sections;
determining, by the processor, one or more second level sections from the plurality of first level sections, wherein each second level section comprises a fixed number of first level sections;
calculating, by a crypto engine, a hash value for each second level section to generate a respective calculated hash value;
calculating, by the crypto engine, a hash value for only each first level section not included in a second level section to generate a respective calculated hash value;
comparing, by the processor, each of the respective calculated hash values with a corresponding stored hash value; and
providing, by the processor, an integrity check indication if each respective calculated hash value is equal to the corresponding stored hash value.

2. The method of claim 1, wherein the crypto engine is a hardware crypto engine.

3. The method of claim 1, wherein each second level section comprises eight first level sections.

4. The method of claim 1, wherein the message comprises a file.

5. An apparatus, comprising:
means for reading a message from a storage device, wherein the message comprises a plurality of first level sections;
means for determining one or more second level sections from the plurality of first level sections, wherein each second level section comprises a fixed number of first level sections;
means for calculating a hash value for each second level section to generate a respective calculated hash value;
means for calculating a hash value for only each first level section not included in a second level section to generate a respective calculated hash value;
means for comparing each of the respective calculated hash values with a corresponding stored hash value; and
means for providing an integrity check indication if each respective calculated hash value is equal to the corresponding stored hash value.

6. The apparatus of claim 5, wherein means for calculating a hash value comprises a hardware crypto engine.

7. The apparatus of claim 5, wherein each second level section comprises eight first level sections.

8. The apparatus of claim 5, wherein the message comprises a file.

9. An apparatus, comprising:
a memory configured to store a message comprising a plurality of first level sections;
a crypto engine configured to calculate, directly from the message, a hash value for a level section; and
a processor configured to:
determine one or more third level sections from the plurality of first level sections, wherein each third level section comprises a first fixed number of first level sections;
determine whether one or more second level sections may be formed from first level sections not included in a third level section, wherein each second level section comprises a second fixed number of first level sections, and the first fixed number is an integer multiple of the second fixed number;
compare each respective calculated hash value calculated for each third level section with a corresponding stored hash value;
compare each respective calculated hash value calculated for each second level section with a corresponding stored hash value;
compare each respective calculated hash value calculated for each first level section, not included in a second level section or a third level section, with a corresponding stored hash value; and
provide an integrity check indication if each respective calculated hash value is equal to the corresponding stored hash value.

10. The apparatus of claim 9, wherein each third level section comprises 256 first level sections, and each second level section comprises 8 first level sections.

11. The apparatus of claim 9, wherein means for calculating a hash value comprises a hardware crypto engine.

12. The apparatus of claim 9, wherein the message comprises a file.

13. A computer-readable medium, comprising:
code for causing a computer to read a message from a storage device, wherein the message comprises a plurality of first level sections;
code for causing a computer to determine one or more second level sections from the plurality of first level sections, wherein each second level section comprises a fixed number of first level sections;
code for causing the computer to calculate a hash value for each second level section to generate a respective calculated hash value;
code for causing the computer to calculate a hash value for only each first level section not included in a second level section to generate a respective calculated hash value;
code for causing the computer to compare each of the respective calculated hash values with a corresponding stored hash value; and
code for causing the computer to provide an integrity check indication if each respective calculated hash value is equal to the corresponding stored hash value.

14. The computer-readable medium of claim 13, wherein each second level section comprises eight first level sections.

15. The computer-readable medium of claim 13, wherein the message comprises a file.
